(19) United States
(12) Patent Application Publication
(10) Pub. No.: US 2023/0040167 A1
(43) Pub. Date: Feb. 9, 2023

(54) Method for performing heat treatment on membrane electrode assembly

(71) Applicants: Hyundai Motor Company, Seoul (KR); Kia Corporation, Seoul (KR)

(72) Inventors: Sun Il Kim, Seoul (KR); Seung Ah Yu, Yongin (KR); Yu Seok Kim, Ansan (KR); Han Hyung Lee, Goyang (KR)

(21) Appl. No.: 17/881,087

(22) Filed: Aug. 4, 2022

(30) Foreign Application Priority Data
Aug. 6, 2021 (KR) 10-2021-0103548

(51) Int. Cl. H01M 4/88; H01M 8/1004; H05B 1/02

(52) U.S. Cl. CPC H01M 4/8882; H01M 8/1004; H01M 4/8896; H05B 1/023; H05B 2203/013

(57) ABSTRACT

Disclosed are a method of heat treating a membrane electrode assembly, in which a first membrane electrode assembly or the like is positioned between a first member and a second member and heat treatment is performed as at least one of the first member and the second member being a heating member, and also in which variation in the temperature of the membrane electrode assembly at different roll positions is decreased and interfacial bonding between the layers in the membrane electrode assembly is enhanced. Thus, the quality of the membrane electrode assembly, such as the durability and performance thereof, may be improved, the yield thereof may be increased, and the amount of heat treatment may be efficiently increased, thereby reducing costs through mass heat treatment and decreasing the rate of processing of the membrane electrode assembly.

### CROSS-REFERENCE TO RELATED APPLICATION

This application claims under 35 U.S.C. § 119(a) the benefit of priority from Korean Patent Application No. 10-2021-0103548, filed on Aug. 6, 2021, the entire contents of which are incorporated herein by reference.

### TECHNICAL FIELD

The present invention relates to a method for performing heat treatment on a membrane electrode assembly.

### BACKGROUND

A fuel cell is a kind of power generator that converts the chemical energy of fuel into electrical energy through an electrochemical reaction in a stack without conversion into heat by combustion.

Such a fuel cell may be applied to supply power not only for industrial and household use and for vehicle driving, but also to supply power for small electric/electronic products, particularly portable devices.

The reaction for generating electricity in a fuel cell occurs in a membrane electrode assembly (MEA), which is a key component of a fuel cell. The membrane electrode assembly typically has a three-layer (3-layer) structure, including an ionomer-based membrane and two electrodes including a cathode formed on one surface of the membrane and an anode formed on the remaining surface thereof.

In particular, heat treatment may be performed in order to manufacture a unit cell including a membrane electrode assembly. For example, heat treatment may increase durability by enhancing the interfacial bonding between the electrodes and the membrane in the membrane electrode assembly.

However, when heat treatment is performed on a roll-type membrane electrode assembly, the extent of heat treatment varies at different internal positions due to the temperature difference at different internal positions of the roll, thus causing inconsistent performance of the membrane electrode assembly depending on the internal position thereof, which is undesirable.

### SUMMARY

In preferred aspects, provided is a method for performing heat treatment on a membrane electrode assembly, in which a first membrane electrode assembly or the like is positioned between a first member and a second member and heat treatment is performed. Particularly, at least one of the first member and the second member being a heating member.

In an aspect, provided is a method for performing heat treatment on a membrane electrode assembly, including preparing a roll-shaped first member having an empty space therein, winding a first membrane electrode assembly on the first member, locating a second member on the outermost portion of the wound first membrane electrode assembly, winding a second membrane electrode assembly on the outermost portion of the second member to obtain a roll product, and heat-treating the roll product. Particularly, at least one of the first member and the second member may be a heating member.

The first member may include a heating element located in the empty space therein.

The second member may be a heating film.

The heating film may be connected to a controller capable of controlling the amount of current.

The controller may be connected to the heating film to control the amount of current.

At least one of the first member and the second member may be a heat pipe.

A pair of heat pipes may be located at the outermost portion of the wound first membrane electrode assembly.

The heat pipe may further include a protrusion protruding from a side of the roll product.

The roll product may be heat-treated in an oven.

Other aspects of the invention are disclosed infra.

### BRIEF DESCRIPTION OF THE DRAWINGS

The above and other features of the present invention will now be described in detail with reference to various exemplary embodiments thereof illustrated in the accompanying drawings which are given hereinbelow by way of illustration only, and thus are not limitative of the present invention, and wherein:

FIG. 1 shows a roll product 100 in which a conventional membrane electrode assembly is wound in a roll form;

FIG. 2 shows an exemplary roll product in which a membrane electrode assembly is wound in a roll form according to an exemplary embodiment of the present invention;

FIG. 3 shows an exemplary roll product in which a membrane electrode assembly is wound in a roll form using a heating film as a second member according to an exemplary embodiment of the present invention;

FIG. 4 shows an exemplary roll product in which a membrane electrode assembly is wound in a roll form using a heat pipe as the second member according to an exemplary embodiment of the present invention;

FIG. 5 shows a part of an exemplary heat pipe according to an exemplary embodiment of the present invention;

FIG. 6A shows an exemplary heat pipe located on the first membrane electrode assembly according to an exemplary embodiment of the present invention, and FIG. 6B shows a pair of exemplary heat pipes located on the first membrane electrode assembly according to an exemplary embodiment of the present invention; and

FIG. 7A shows an exemplary roll product in which a membrane electrode assembly is wound in a roll form using a heat pipe having a protrusion as the second member according to an exemplary embodiment of the present invention, and FIG. 7B shows an exemplary roll product in which the membrane electrode assembly is wound in a roll form using the heat pipe having a protrusion as the second member according to an exemplary embodiment of the present invention.

### DETAILED DESCRIPTION

The above and other objects, features and advantages of the present invention will be more clearly understood from the following preferred embodiments taken in conjunction with the accompanying drawings. However, the present invention is not limited to the embodiments disclosed herein, and may be modified into different forms. These embodiments are provided to thoroughly explain the invention and to sufficiently transfer the spirit of the present invention to those skilled in the art.

Throughout the drawings, the same reference numerals will refer to the same or like elements. For the sake of clarity of the present invention, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present invention. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

In the present specification, when a range is described for a variable, it will be understood that the variable includes all values within the stated range, including the end points. For example, the range of “5 to 10” will be understood to include any subranges, such as 6 to 10, 7 to 10, 6 to 9, 7 to 9 and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

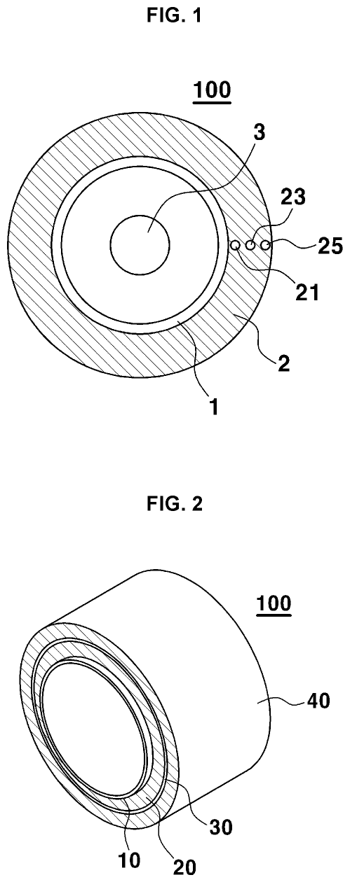

FIG. 1 shows a cross-sectional view of a roll product 100 in which a conventional membrane electrode assembly is wound in a roll form. With reference thereto, a membrane electrode assembly 100, in which a heating element 3 is located in a roll-shaped first member 1 having an empty space therein and in which a membrane electrode assembly 2 is wound in a roll form on the outermost portion of the roll-shaped first member 1, may be placed in an oven and then heat-treated. For example, the wound membrane electrode assembly 2 may include a core portion 21 adjacent to the first member 1, a middle portion 23, and an outer portion 25 adjacent to the outside, and, due to the heating element and the supply of heat from outside during heat treatment, the temperature difference between the core portion and the outer portion is not very large, but the temperature of the middle portion is lower than that of the core portion or the outer portion. In particular, when heat treatment is performed on the conventional roll-type membrane electrode assembly, the extent of heat treatment varies at different internal positions due to the temperature difference at different internal positions of the roll, and thus, variation in the performance of the membrane electrode assembly depending on the internal position thereof occurs, which is undesirable.

In an aspect, provided is a method for heat treatment of a membrane electrode assembly. The method may include: positioning a first membrane electrode assembly or the like between the first member and the second member, at least one of which is a heating member. Particularly, the temperature difference at different roll positions may be decreased, so interfacial bonding between layers in the membrane electrode assembly may be enhanced. During heat treatment of the roll-type membrane electrode assembly, variation in the temperature of the membrane electrode assembly at different roll positions may be decreased, thus reducing the difference in the extent of heat treatment at different roll positions. In addition, variation in the performance of the membrane electrode assembly depending on the internal position thereof may be decreased, and the interfacial bonding between layers in the membrane electrode assembly may be enhanced. As such, the quality of the membrane electrode assembly, such as the durability and the like may be improved, the yield may increase compared to a conventional hot-press heat treatment method, and the amount of heat treatment may be efficiently increased, thereby completing a method for performing heat treatment on a membrane electrode assembly.

FIG. 2 shows an exemplary roll product in which a membrane electrode assembly is wound in a roll form according to an exemplary embodiment of the present invention. The method for performing heat treatment on a membrane electrode assembly according to an exemplary embodiment of the present invention includes preparing a roll-shaped first member 10 having an empty space therein, winding a first membrane electrode assembly 20 on the first member, locating a second member 30 on the outermost portion of the wound first membrane electrode assembly, winding a second membrane electrode assembly 40 on the outermost portion of the second member to obtain a roll product 100, and heat-treating the roll product 100, at least one of the first member 10 and the second member 30 being a heating member. Here, the roll product may be heat-treated in an oven.

Particularly, in the method for performing heat treatment on the membrane electrode assembly according to an exemplary embodiment of the present invention, the second member may be located between the first membrane electrode assembly and the second membrane electrode assembly, so temperature variation in the middle portion, having a relatively low temperature in a conventionally wound membrane electrode assembly, may be decreased. As consequence, the difference in the extent of heat treatment at different roll positions may be reduced, whereby variation in the performance of the membrane electrode assembly depending on the internal position thereof is reduced and interfacial bonding between layers in the membrane electrode assembly is enhanced, thus improving the quality of the membrane electrode assembly, such as the durability, etc. thereof, increasing the yield compared to a conventional hot-press heat treatment method, and efficiently increasing the amount of heat treatment.

In the method for performing heat treatment on the membrane electrode assembly according to an exemplary embodiment of the present invention, a different roll product may be obtained depending on the type of the first member or the second member, followed by heat treatment.

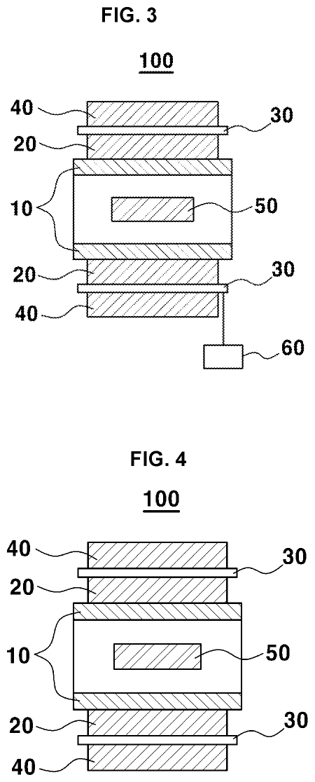

Particularly, in the method for performing heat treatment on the membrane electrode assembly according to an exemplary embodiment of the present invention, a roll product may be obtained using a heating film as the second member, and the membrane electrode assembly may be heat-treated. FIG. 3 shows the roll product in which a membrane electrode assembly is wound in a roll form using a heating film as the second member according to an embodiment. For example, the cross-section of the roll product is shown, and includes a roll-shaped first member 10 having an empty space therein, a first membrane electrode assembly 20 wound on the first member, a second membrane 30 located at the outermost portion of the wound first membrane electrode assembly, and a second membrane electrode assembly 40 wound on the outermost portion of the second member.

The first member 10 may include a heating element 50 located in the empty space therein and the second member as being the heating film may be connected to a controller 60 including a sensor 61 at the core portion of the first membrane electrode assembly and a sensor 65 at the outer portion of the second membrane electrode assembly.

As the second member, the heating film is not particularly limited, so long as it is located between the first membrane electrode assembly and the second membrane electrode assembly to thus decrease the temperature difference between the first membrane electrode assembly and the second membrane electrode assembly. Preferably, the heating film may include a heat-resistant film having a heating wire inserted therein.

The heat-resistant film that may be used as the heating film may include at least one of polyamide and copper foil, and is not limited to including a specific component.

During heat treatment of the membrane electrode assembly, which is a roll product using the heating film as the second member, the heating film may be inserted at the middle position of the roll-type wound membrane electrode assembly to apply additional heat, so temperature variation in the middle portion of the wound membrane electrode assembly may be decreased.

In particular, the heating film may be connected to a controller capable of controlling the amount of current, making it possible to efficiently adjust the temperature. For example, the controller 60 may be configured such that the temperatures of the core portion of the first membrane electrode assembly and the outer portion of the second membrane electrode assembly are measured using the sensor 61 at the core portion of the first membrane electrode assembly adjacent to the first member and the sensor 65 at the outer portion of the second membrane electrode assembly adjacent to the outermost portion of the roll product, after which the amount of current is controlled using a control unit (not shown), thereby adjusting the temperature of the heating film, ultimately decreasing the temperature difference between the first membrane electrode assembly and the second membrane electrode assembly.

Moreover, in the method for performing heat treatment on the membrane electrode assembly according to an exemplary embodiment of the present invention, a roll product may be obtained using a heat pipe as at least one of the first member and the second member, and the membrane electrode assembly may be heat-treated.

FIG. 4 shows a cross-sectional view of an exemplary roll product in which a membrane electrode assembly is wound in a roll form using a heat pipe as the second member according to an exemplary embodiment of the present invention. Particularly, the roll product includes a roll-shaped first member 10 having an empty space therein, a first membrane electrode assembly 20 wound on the first member, a second member 30 located at the outermost portion of the wound first membrane electrode assembly, and a second membrane electrode assembly 40 wound on the outermost portion of the second member. Here, the first member 10 may include a heating element 50 located in the empty space therein.

On the other hand, the heating element 50 may not be located in the empty space in the first member 10. In this case, the first member may also be a heat pipe, in addition to the second member.

The heat pipe, which may be used for the first member or the second member, may have thermal conductivity of about 5,000 to 100,000 W/mk, corresponding to thousands of times that of copper.

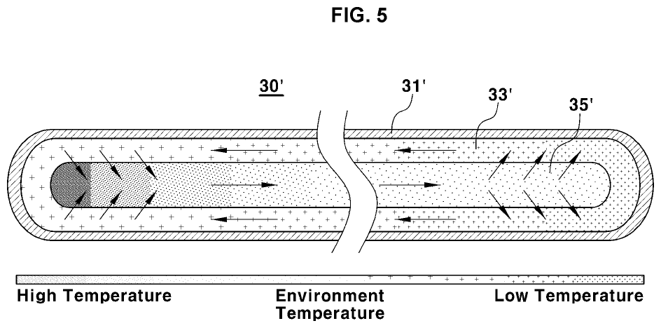

FIG. 5 shows a cross-sectional view of part of an exemplary heat pipe according to an exemplary embodiment of the present invention. With reference thereto, the heat pipe 30′ includes a case 31′ surrounding the outer surface of the heat pipe, a wick 33′ located in the case and having a capillary structure, and a vapor cavity 35′, which is an empty space inside the wick, and a working fluid may be contained within the wick.

The process of heat conduction by the heat pipe is as follows. When the wound roll product is heat-treated in an oven, a temperature gradient may be formed in a manner in which the temperature at one end of the heat pipe is relatively high due to the heat and the inside of the heat pipe has a relatively low temperature. For example, the working fluid, which is located within the wick at the high-temperature end of the heat pipe, may absorb thermal energy and evaporates in the form of a vapor into the vapor cavity. The vapor of the evaporated working fluid may move toward the portion having the lower temperature, and the vapor of the moved working fluid may be condensed inside of the heat pipe at which the temperature is relatively low, and may move again as the working fluid into the wick. This makes it possible to conduct heat efficiently.

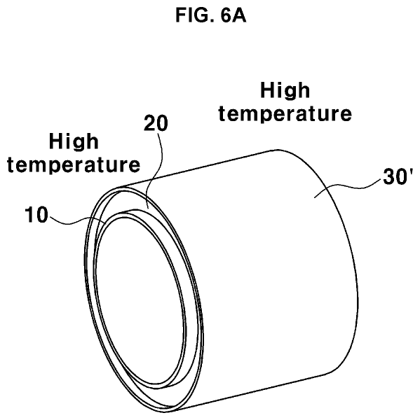

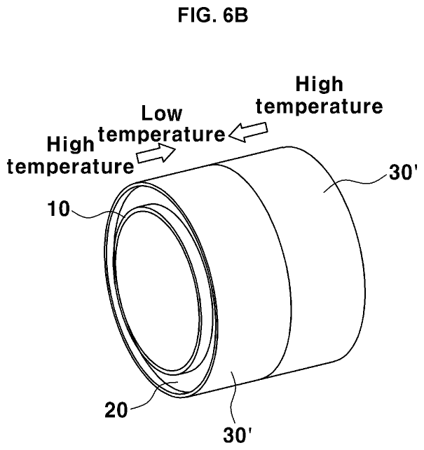

FIG. 6A shows that one heat pipe is located on the first membrane electrode assembly according to an exemplary embodiment of the present invention. For example, both ends of the heat pipe may have a high temperature. Here, since it is difficult to form a temperature gradient, heat conduction efficiency may be lowered, and finally, the efficiency of the heat pipe may be lowered.

FIG. 6B shows a perspective view of a pair of exemplary heat pipes located on the first membrane electrode assembly according to an exemplary embodiment of the present invention. With reference thereto, even when opposite outer ends of the heat pipes have a high temperature, the inner ends of the heat pipes in contact with each other may have a low temperature, so it is easy to form a temperature gradient, and thus the efficiency of the heat pipe is vastly superior.

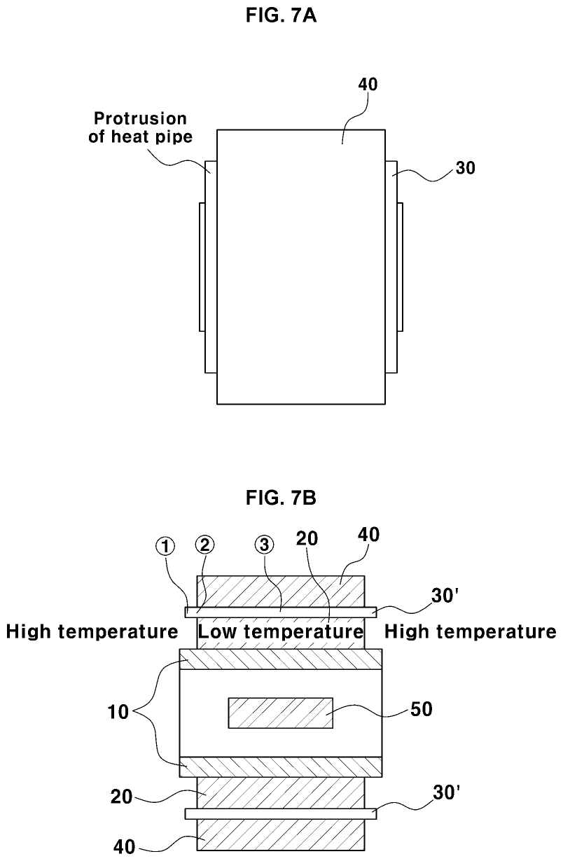

FIG. 7A shows a side view of an exemplary roll product in which a membrane electrode assembly is wound in a roll form using a heat pipe having a protrusion as the second member according to an embodiment.

theretofore example, the heat pipe may also include a protrusion protruding from the side of the roll product.

FIG. 7B shows a cross-sectional view of an exemplary roll product in which the membrane electrode assembly is wound in a roll form using a heat pipe having a protrusion as the second member according to an exemplary embodiment of the present invention.

With reference thereto, the temperatures of portions of the heat pipe are high in the order of \textcircled{1}>\textcircled{2}>\textcircled{3}. Here, since the temperature gradient (\textcircled{3} to \textcircled{1}) of the heat pipe having the protrusion is greater than the temperature gradient (\textcircled{2} to \textcircled{1}) of the heat pipe having no protrusion, the heat conduction efficiency of the heat pipe may increase in the presence of the protrusion.

Therefore, according to an exemplary embodiment of the present invention, when the second member is a heat pipe, it is more preferable that a pair of heat pipes be provided and include a protrusion protruding from the side of the roll product. For example, when the heating element is not located in the empty space in the first member, it is preferable that a pair of heat pipes be provided as the first member.

Particularly, in the method for performing heat treatment on the membrane electrode assembly according to an exemplary embodiment of the present invention, the first membrane electrode assembly or the like may be positioned between the first member and the second member and heat treatment may be performed, at least one of the first member and the second member being a heating member. Since the heating member includes a specific configuration suitable for the heating film or the heat pipe, variation in the temperature of the membrane electrode assembly at different roll positions is decreased, thus reducing the difference in the extent of heat treatment at different roll positions. In addition, variation in the performance of the membrane electrode assembly depending on the internal position thereof may be reduced, and the interfacial bonding between layers in the membrane electrode assembly may be enhanced, thus improving the quality of the membrane electrode assembly, such as the durability and the like and increasing the yield compared to a conventional hot-press heat treatment method. Moreover, the amount of heat treatment can be efficiently increased so that the total length of the membrane electrode assembly that is wound can be extended from about 500 m without limitation through insertion of a heating film and a heat pipe, thereby reducing costs through mass heat treatment and decreasing the rate of processing of the membrane electrode assembly.

As is apparent from the above description, in the method for performing heat treatment on a membrane electrode assembly according to various exemplary embodiments of the present invention, during heat treatment of a roll-type membrane electrode assembly, variation in the temperature of the membrane electrode assembly at different roll positions can be decreased, thereby reducing a difference in the extent of heat treatment at different roll positions. Variation in the performance of the membrane electrode assembly depending on the internal position thereof can be reduced, so interfacial bonding between layers in the membrane electrode assembly can be enhanced, and thus, the quality of the membrane electrode assembly, such as the durability and the like is improved, yield is increased compared to a conventional hot-press heat treatment method, and the amount of heat treatment can be efficiently increased, making it possible to reduce costs through mass heat treatment and to decrease the rate of processing of the membrane electrode assembly.

Although specific embodiments of the present invention have been described with reference to the accompanying drawings, those skilled in the art will appreciate that the present invention may be embodied in other specific forms without changing the technical spirit or essential features thereof. Thus, the embodiments described above should be understood to be non-limiting and illustrative in every way.

What is claimed is:

1. A method of heat treating a membrane electrode assembly, comprising:
preparing a roll-shaped first member having an empty space therein;
winding a first membrane electrode assembly on the first member;
locating a second member on an outermost portion of the wound first membrane electrode assembly;
winding a second membrane electrode assembly on an outermost portion of the second member to obtain a roll product; and
heat-treating the roll product,
wherein at least one of the first member and the second member comprises a heating member.

2. The method of claim 1, wherein the first member comprises a heating element located in the empty space therein.

3. The method of claim 1, wherein the second member comprises a heating film.

4. The method of claim 3, wherein the heating film is connected to a controller capable of controlling an amount of current.

5. The method of claim 4, wherein the controller is connected to the heating film to control the amount of current.

6. The method of claim 1, wherein at least one of the first member and the second member comprises a heat pipe.

7. The method of claim 6, wherein a pair of heat pipes is located at the outermost portion of the wound first membrane electrode assembly.

8. The method of claim 6, wherein the heat pipe further comprises a protrusion protruding from a side of the roll product.

9. The method of claim 1, wherein the roll product is heat-treated in an oven.
